(19) United States
(12) Patent Application Publication
(10) Pub. No.: US 2010/0299245 A1
(43) Pub. Date: Nov. 25, 2010

(54) Web-based home-loan assessment system and mortgage brokerage service

(76) Inventor: Bruce F. Kaufman, Novi, MI (US)

Correspondence Address: Gerald R. Black, Esq., Suite 67A, 30320 Southfield Road, Southfield, MI, 48076, US

(21) Appl. No.: 12/798,860

(22) Filed: Apr. 13, 2010

Related U.S. Application Data
(60) Provisional application No. 61/212,447, filed on Apr. 13, 2009.
(60) Provisional application No. 61/280,451, filed on Nov. 5, 2009.

(51) Int. Cl. G06Q 40/00

(52) U.S. Cl. 705/38

(57) ABSTRACT

“The web-based home-loan modification assessment system prepares a detailed financial statement of borrower's income and expenses that the lender uses in determining whether or not to modify the borrower's mortgage agreement. The website is designed to streamline the information gathering process. The data input device can be a keypad, a pda, or a phone. The borrower answers questions about his current financial status. Once submitted, the personal data is organized into a request form for a loan modification. The processor determines the amount that the borrower is able to afford using either a front end debt-to-income ratio, or back end debt-to-income ratio. The net present value of the real property is then calculated. The request form is then submitted to the borrower for review and approval in real time. If the calculations support modifying the mortgage agreement, the information is submitted to the lender for consideration.”

This Application is related to and claims priority to U.S. Provisional Application No. 61/212,447, entitled “Home Loan Affordability Assessment System and Method” filed on Apr. 13, 2009; and U.S. Provisional Application No. 61/280,451, entitled “Improved Home Loan Affordability Assessment System and Method” filed on Nov. 5, 2009.

### FIELD OF THE INVENTION

The present invention generally relates to assessment systems and methods for processing home-loan information. More particularly, the invention relates to combination web-based loan modification assessment systems and methods for processing home-loan modifications for a borrower and mortgage brokerage services and related transactions.

### BACKGROUND OF THE INVENTION

The growth of the U.S. gross domestic product over the past 15 years was mainly the result of Americans buying an abundance of goods and services (i.e.—vehicles, household electronics, second homes, and vacations). Many of these items were financed using personal household credit in the form of credit cards. Eventually home equity loans were used to pay this credit card debt.

The subprime mortgage crisis was triggered by a dramatic rise in mortgage delinquencies and foreclosures in the United States, with major adverse consequences for global banks and financial markets. The crisis had its roots at the close of the 20^{th} century, becoming apparent in 2007 and exposed pervasive weaknesses in global financial industry regulation and system. About 80% of U.S. mortgages issued in recent years to subprime borrowers were adjustable-rate mortgages. After U.S. house prices peaked in mid-2006, they began their steep decline thereafter, and refinancing became more difficult. As adjustable-rate mortgages began to reset at higher rates, mortgage delinquencies soared. Securities backed with subprime mortgages, widely held by lenders, lost most of their value. The result has been a large decline in the capital of many banks and U.S. government sponsored enterprises, tightening credit around the world.

The foreclosure problem started when the financial services industry developed non-traditional types of mortgage products that allowed homeowners to purchase homes with no money down and the only financial requirement was that buyers needed 6 months of loan and property tax payments in reserve. Millions of homeowners stripped the built up equity in their homes for non-essential purchases of consumer goods. In theory, this concept helped keep our economy growing. However, the long-term financial security of millions of Americans was compromised by eliminating the equity buildup in their homes.

The lax financial underwriting standards that were implemented for home loan purchases from 2002 to 2006 caused a major inflationary bubble in residential real estate. Millions of people were encouraged to buy homes that they really could not afford, with minimum down payments, and minimal oversight, with the expectation that the home real estate market would continue to be hold value and be a sound investment. When home real estate market values dropped, the engine that was driving this credit cycle collapsed, and homeowners and the lending institutions holding these notes were in peril.

The federal government enacted the Making Home Affordable (MHA) loan modification program is seeking to help between 3 and 4 million homeowners over the next three years. No program has previously attempted to modify so many mortgages at such affordable terms for borrowers. The federal government is seeing real results—modifications that provide long-term solutions for borrowers.

Financial systems receive information and process the received information to produce an output that is useful to a user, such as a business person. For example, a financial system may produce financial reports, financial summaries, and/or entries in a ledger.

Financial systems for processing loans in the banking and mortgage industry face numerous challenges. One of those challenges is associated with gathering and processing information during the life of a mortgage. For example, during the life of a mortgage, various business processes are associated with the mortgage including, for example, a mortgage may be entered into by a mortgagor and a mortgagee; a mortgagor may sell the mortgage to another mortgagor; a mortgage may be serviced by a mortgage servicer that may be independent from the mortgagor; a mortgage may go into delinquency status with past due mortgage payments; a mortgage may go into foreclosure status; a mortgagor may retake possession of the property after foreclosure; the repossessed property may generate income and/or expenses; the repossessed property may be resold which thus retires the original mortgage; a mortgage may be refinanced; a mortgage may be renegotiated (also referred to as a “work-out”) at a new interest rate amount thus mitigating the risk of foreclosure.

The various business processes associated with the mortgage may not be under the control of a single financial institution, such as a mortgagor, mortgage servicer, or mortgage note owner. In fact, some of these business processes may be performed by one or more independent financial institutions or business entities. For example, an independent business entity, such as a mortgage servicer, may use a financial system that is separate and incompatible with the mortgagor's financial system even though the mortgagor requires information related to servicing a mortgage for accounting and financial reasons. Accordingly, when processing loans, such as mortgages, a lender or mortgagor faces a challenge when collecting and then processing information from various business entities with financial systems that may not be compatible with the mortgagor's financial system. As a result, the financial systems used to processes loans in the banking or mortgage industry may be costly and cumbersome to implement.

Several Patents and Patent Applications address problems that borrowers have trying to obtain relief under the current system:
U.S. patent application Ser. No. 12/504,350 (Fraser et al.) discloses an interactive mortgage and loan information and real-time trading system. Loan applications, such as home mortgage loan applications, are made available electronically to receive bids from a plurality of potential lenders. A transaction server maintains a database of pending loan applications and their statuses, which is accessible over the Internet. Each party to a loan can search and modify the database consistent with their role in a transaction.
U.S. patent application Ser. No. 11/893,805 (Cznadel et al.) discloses a system and method for financially distressed persons to avoid foreclosure. The system, method and computer program product for enabling owner/debtor's particularly, of dwellings, who are in financial distress and may be entering into a home foreclosure, to avoid the foreclosure by enabling them to purchase another real-estate property as joint or co-owner with another debtor. Immediate beneficial effect of such an equity purchasing arrangement for all parties is realized. For instance, based on pool membership and an affordability factor rating, customers may be immediately extricated from the foreclosure process, advantageously matched with another borrower using calculations provided by the system, and placed in an equity home co-ownership situation.
U.S. patent application Ser. No. 11/602,825 (Wegmann et al.) discloses a system and method for refinancing mortgages. The method comprises storing key mortgage loan information associated with a borrower, including data identifying the borrower, an amount of the mortgage loan, a rate of interest payable on the mortgage loan, and the term of the mortgage loan, and inputting market-available refinance data to the computer, wherein the market-available refinance data includes at least one of an interest rate and a loan program. The method also includes automatically comparing the market-available refinance data to the key mortgage loan information associated with the borrower to determine whether the market-available refinance data includes either a reduced finance rate or a shorter term than the borrower's current loan information, and if so, automatically executing a refinance rate lock for the borrower.
U.S. Pat. No. 7,287,008 (Mahoney et al.) discloses a system and method for use by a business entity for loan origination and underwriting in connection with real estate investment using a computer implemented application having a plurality of data input and dialog screens requiring one-time entry of data. The method includes steps to be followed in any sequence by one or more users of the business entity for using the system. The method includes inputting and storing loan origination information via data input screens, the information including financial and physical information relating to a specific real estate investment. The input loan origination information is dynamically compared with pre-determined rules and a dialog screen is displayed on a near real-time basis if any of said rules are violated. The input data is dynamically compared with other rules for determining the ongoing sequence of data input and dialog screens.
U.S. Pat. No. 6,904,412 (Broadbent et al.) discloses an automated compliance engine that uses federal, state, local and professional regulations and requirements and implementing instructions to generate a plurality of tasks which can be used to control and drive the process of handling a mortgage loan application to completion and to monitor the completion of the tasks in order to generate a Completion Certificate.
U.S. Pat. No. 5,930,775 (McCauley et al.) discloses a system for processing real estate loans based on loan data including personal data relating to a borrower, financial information relating to the borrowers financial position, and loan conditions including a loan term and information on the corresponding real estate, related to a real estate loan. Such methods, system, and article of manufacture generate a comparison model including an ability-to-pay rate reflecting an interest rate on the loan reflecting the borrowers ability to repay a loan having the loan conditions, a default rate reflecting an interest rate realizable if the loan is foreclosed and a new loan secured by the real estate originated, and a minimum rate reflecting an interest rate realizable if proceeds from a sale of the real estate before expiration of the loan term are determined to be acceptable and a new loan secured by the real estate originated. Using a relationship determined from the ability-to-pay.

Returning to the example of the business process of servicing a mortgage, a mortgage servicer services the mortgage for a mortgagor by collecting mortgage payments from a mortgagee. Each collected mortgage payment creates a financial transaction or event. The mortgage servicer—as an independent business entity—may need to process the financial transaction to record the mortgage payment and make any necessary accounting entries. The mortgage servicer may then report the mortgage payment to the mortgagor. The mortgagor then makes the appropriate accounting entries and generates reports based on the reported information. Since the mortgage servicer may be a business entity that is independent and separate from the mortgagor, the mortgage servicer may maintain financial systems for servicing a mortgage that are separate from the mortgagor. Moreover, if the mortgage servicer makes a change affecting the format of the financial information collected by the mortgage servicer's financial system, the mortgagor may need to make a corresponding change to the mortgagors financial system before receiving the mortgage servicers information. Similarly, if the mortgagor makes a format change to its financial information, the mortgage servicer may need to make a corresponding change, which makes financial systems for the loan and mortgage industry cumbersome and costly to develop and maintain.

CNN.Money reported on Apr. 3, 2009, that a recent government report found that mortgages modified with affordability in mind redefault at half the rate of other adjusted loans. The President is counting on financial institutions and housing counselors to work together on loan modifications to pull the nation out of the mortgage crisis. Loan modifications are at the center of this plan.

A glance at world markets shows that this problem is not unique to the U.S. Ireland's housing prices dropped 5.83% in the 4^{th} quarter of 2009, the biggest drop since records have been kept. In Spain, house prices fell 6.42% during 2009. In Kiev, Ukraine, house prices fell 30.22% during 2009. Russia's housing market is in crisis and fell 19.97% in 2009. However, the biggest price-declines in the world during this crisis have taken place in Riga, Latvia (down 50.22% in 2009, after a fall of 36.98% in 2008), and in Dubai, UAE which dropped 43.29% in 2009.

Accordingly, an urgent need exists for a web-based home-loan modification system and mortgage brokerage service that enables users to determine all relevant information about a real property in real time, including the fair market value of the property and the most recent trends in the neighborhood, so that the users can make sound decisions about the future of their single biggest financial investment.

What is needed is a web-based system and method to enable borrowers, many of whom are financially distressed by this economic downturn, to obtain fair and affordable relief from high monthly mortgage payments that they can no longer afford and that no longer reflect the value of the real property, that the lender can no longer realistically expect to recover in this depressed housing market, which allows the borrowers to stay in their homes, avoiding default and relocation expenses, without further disrupting the lives of their families and achieve a realistic means for financial recovery without further depressing the value of neighboring home values, and which will stabilize the financial sector and turn this economy around.

### SUMMARY OF THE INVENTION

All of these needs are addressed by the web-based home-loan modification system and mortgage brokerage service of the present invention.

The system and method of the present invention are for use in preparing a detailed financial statement of borrower's income and expenses that the lender uses in making an informed determination on whether or not to modify the borrower's mortgage agreement. The home-loan modification assessment system comprises a website, a data input device, and a processor. The website is easily found on the Internet using common search engines. The borrower can readily query the website for issues that impact him and recent changes in the law and regulations. The website is user-friendly and is specifically designed to streamline the process. The data input device can be a keypad or a phone. The borrower submits answers online to the user-friendly questionnaire through the website about his current financial status and his mortgage agreement with the lender. Once the personal data has been submitted through the website, a processor associated with the website organizes the personal data into a request form for a loan modification. The website processor determines the amount that the borrower is able to afford using either a front end debt-to-income ratio, or back end debt-to-income ratio. The net present value of the real property is then calculated, the net present value being a function of net proceeds the lender receives from the real property if the borrower defaults. The request form is then submitted to the borrower for review and approval in real time. If the calculations support proceeding to default, there is no need to submit a request for a home-loan modification. If the calculations support modifying the mortgage agreement, the information is submitted to the lender for review and consideration. The lender decision to modify the mortgage agreement is at least partially based upon a determination of the net present value.

The web-based home-loan modification system of the present invention also preferably includes a web-based mortgage brokerage service system that enables personal data to be submitted and organized for subsequent consideration for application to a mortgage broker or lender to qualify for a mortgage on a second real property, said mortgage application being submitted for review by said user in real time.

The web-based home-loan modification system of the present invention also preferably includes a web-based rental assessment service enabling said user to conduct a market analysis through said website of targeted rental properties in a selected neighborhood, said market analysis being available to said user in real time.

Lenders generally do not want these residential properties. The average foreclosure costs the mortgage lender $60,000. A foreclosed home may be unoccupied for months, depreciating the value of the entire neighborhood.

However, a lender cannot make a decision to modify a mortgage unless the lender has current and complete information about the borrower's financial situation. If a lender can make more money by working out a new loan plan with the borrower instead of foreclosing, then the lender will work with the borrower. However, if the borrower cannot prove that he can still afford the home even with a new lower monthly payment, then the lender must proceed with the foreclosure.

Renegotiating the terms of the mortgage can be very frustrating. We know how difficult it is to get someone to just talk to a borrower at the mortgage company and advise a borrower of his options.

The system and method of the present invention helps prepare a detailed financial statement of borrower's income and expenses that the lender will need in making an informed determination on whether to modify the mortgage or not.

The web-based home-loan modification system and mortgage brokerage service of the present invention present invention helps prepare a detailed financial statement of borrower's income and expenses that the lender will need in making an informed determination on whether to modify the mortgage or not. The assessment method comprises submitting and processing personal data regarding the financially-distressed borrower, so as to determine the amount that the financially-distressed borrower are able to afford utilizing either a front end debt-to-income ratio, or back end debt-to-income ratio. The net present value of the real estate property is then calculated. If the ratios support modifying the mortgage agreement, a new agreement is made. If the ratios support proceeding to foreclosure, then foreclosure will proceed.

A default by borrower is a foreclosure, a short sale, a deed in lieu of foreclosure, or any other situation where the borrower breaches the mortgage agreement with the lender.

As used herein, a foreclosure is the legal proceeding in which a lender obtains a court ordered termination of a borrowers equitable right of redemption. Usually, the lender obtains a security interest from the borrower who mortgages the home to secure the loan. If the borrower defaults and the lender tries to repossess the property, courts of equity can grant the borrower the equitable right of redemption if the borrower repays the debt. While this equitable right exists, the lender cannot be sure of successfully repossess the property. Hence, the lender seeks to foreclose the equitable right of redemption. The foreclosure process as applied to residential mortgage loans is a lender selling or repossessing a parcel of real property (immovable property) after the owner has failed to comply with an agreement between the lender and borrower called a “mortgage”. A foreclosure is a borrower default.

As used herein, a short sale is a sale of real estate in which the sale proceeds fall short of the balance owed on the property's loan. It often occurs when a borrower cannot pay the mortgage loan on their property, but the lender decides that selling the property at a moderate loss is better than pressing the borrower. Both parties consent to the short sale process, because it allows them to avoid foreclosure, which involves significant fees for the lender and a poorer credit report outcome for the borrower. This agreement, however, does not necessarily release the borrower from the obligation to pay the remaining balance of the loan. In a short sale, the lender agrees to discount a loan balance because of an economic or financial hardship on the part of the borrower. The borrower sells the mortgaged property for less than the outstanding balance of the loan, and turns over the proceeds of the sale to the lender. Neither side is “doing the other a favor;” a short sale is simply the most economical solution to a problem. A short sale is a borrower default.

As used herein, a deed in lieu of foreclosure is a deed instrument in which the borrower conveys all interest in a real property to the lender to satisfy a loan that is in default and avoid foreclosure proceedings. The principal benefit to the borrower is that it immediately releases the borrower from most or all of the personal indebtedness associated with the defaulted loan. The borrower also avoids the notoriety of a foreclosure and may receive more generous terms than are available in a formal foreclosure. Another benefit is that it does less damage to a credit rating than a foreclosure. Advantages to a lender include a reduction in the time and cost of a repossession, lower risk of borrower revenge (metal theft and vandalism of the property before sheriff eviction), and additional advantages if the borrower subsequently files for bankruptcy. A deed in lieu of foreclosure is a borrower default.

As used herein, a reverse mortgage is a loan available to seniors, and is used to release the home equity in the property as one lump sum or multiple payments. The homeowner's obligation to repay the loan is deferred until the owner dies, the home is sold, or the homeowner leaves. In a reverse mortgage, the homeowner makes no payments and all interest is added to the lien on the property. If the homeowner receives monthly payments, or a bulk payment of the available equity percentage, then the debt on the property increases each month. If a property has increased in value after a reverse mortgage is taken out, it is possible to acquire another reverse mortgage over the increased equity in the home. The older the homeowner is, the more lenient the qualifications are, as the mortality rate increases with age. Once the homeowner applies and has been given the proper information and consultation with a seasoned professional, the homeowner is attends a counseling session. During the loan and the remainder of its life, the homeowner cannot be asked to leave the property, as the homeowner is still the deed holder. When the homeowner passes, the heirs are still entitled to the property, who may refinance it out of the reverse mortgage. If they decide not to reside in the property, they can sell the unit, pay off the reverse mortgage, and keep the balance of the monies of the estate. From the time of passing of the homeowner, the heirs have one year to settle the mortgage.

As used herein, in real time means the application must be performed within context to be mission critical, regardless of the system load. A simple example of real time is the anti-lock brakes on a car, which require a real-time computing system. The real-time constraint in the braking system is the short time in which the brakes must be released to prevent the wheel from locking. A system is said to be real-time if the total correctness of an operation depends not only upon its logical correctness, but also upon the time in which it is performed. Real-time computations can be said to have failed if they are not completed before their deadline, where the deadline is relative to an event.

White the web-based home-loan modification assessment system and mortgage brokerage service of the present invention has application in global economies in any and all countries throughout the world as a result of the turbulence in world financial markets, for purposes of illustration only this Application will focus on the home mortgage crises in the U.S. However, it is to be understood that the principles of the present invention apply to any and all countries, wherever there is a destabilization in housing markets, and the turbulence in financial markets resulting therefrom.

It is to be understood that both the foregoing general description and the following detailed description of the combination web-based loan assessment system and mortgage brokerage system of the present invention are exemplary and explanatory only and are not restrictive of the invention, as described. Further features and/or variations may be provided in addition to those set forth herein. For example, the present invention may be directed to various combinations and sub-combinations of the disclosed features and/or combinations and sub-combinations of several further features disclosed below in the detailed description. As the invention may be embodied in many forms without departing from spirit of essential characteristics thereof, it is expressly understood that the drawings are for purposes of illustration and description only, and are not intended as a definition of the limits of the invention.

### BRIEF DESCRIPTION OF THE DRAWINGS

The accompanying drawings, which are incorporated in and constitute a part of this specification, illustrate various embodiments and aspects of the present invention and, together with the description, explain the principles of the invention. In the drawings:

FIG. 1 discloses the preferred embodiment of the web-based home-loan modification system and mortgage brokerage service of the present invention.

FIGS. 2A, 2B, and 2C are three preferred embodiments of the web-based home-loan modification assessment component of the web-based home-loan modification system and mortgage brokerage service of FIG. 1.

FIG. 3A is a simplified block diagram demonstrating a first preferred embodiment of a loan modification analysis involving the steps of entering the financial information into the computer for the web-based home-loan modification assessment system of FIGS. 2A, 2B, or 2C.

FIG. 3B is a simplified block diagram demonstrating a second preferred embodiment of a loan modification analysis involving the steps of entering the financial information into the computer for the web-based home-loan modification assessment system of FIGS. 2A, 2B, or 2C.

FIG. 4 is a flow chart of how the financial calculations pertaining to the rate of return on investment using of the web-based home-loan modification assessment method of the present invention.

FIG. 5 is a flow chart of how the formulated reports are analyzed by internal loan modification representatives using the web-based home-loan modification assessment method of the present invention.

FIG. 6A is a flow chart for a deed in lieu of foreclosure for use with the web-based home-loan modification assessment method of the present invention; and FIG. 6B is a flow chart for a loan modification for use with the web-based home-loan modification assessment method of the present invention.

FIG. 7 is a balance sheet demonstrating how the web-based home-loan modification assessment analysis of FIGS. 3A and 3B recommends a loan modification or some other alternative.

FIGS. 8A, 8B, and 8C are three preferred embodiments of the web-based mortgage brokerage service component of the web-based home-loan modification system and mortgage brokerage service of FIG. 1.

FIG. 9 discloses the preferred embodiment of the web-based home-loan modification assessment method for use with the home-loan assessment system of the FIGS. 1A, 1B, or 1C, the method enabling a user to calculate a new house payment that is affordable for the user based upon personal data submitted online via a user-friendly website, the method also enabling the user to determine the amount of a mortgage that he would qualify for on another property online via the user-friendly website, and the method enabling the user to conduct a market analysis of relevant rental properties in selected communities online via the user-friendly website.

FIG. 10A discloses a market comparison of homes sales that were recently sold in a selected area for use with the web-based home-loan modification assessment system of the present invention, which provides a user with additional information to enable the user to make an informed decision about future renegotiations based upon current market conditions.

FIG. 10B discloses a market comparison of homes currently for sale from the Multiple Listing Service® in a selected area for use with the web-based home-loan modification assessment system of the present invention, which provides a user with additional information to enable the user to make an informed decision about future renegotiations based upon current market conditions.

FIG. 10C discloses a market comparison of homes currently available for rent in a selected area for use with the web-based home-loan modification assessment system of the present invention, which provides a user with additional information to enable the user to make an informed decision about future renegotiations based upon current market conditions.

FIG. 11 discloses a typical worksheet generated by the web-based home-loan assessment system of the present invention to determine the financial status of a buyer.

### DETAILED DESCRIPTION OF THE INVENTION

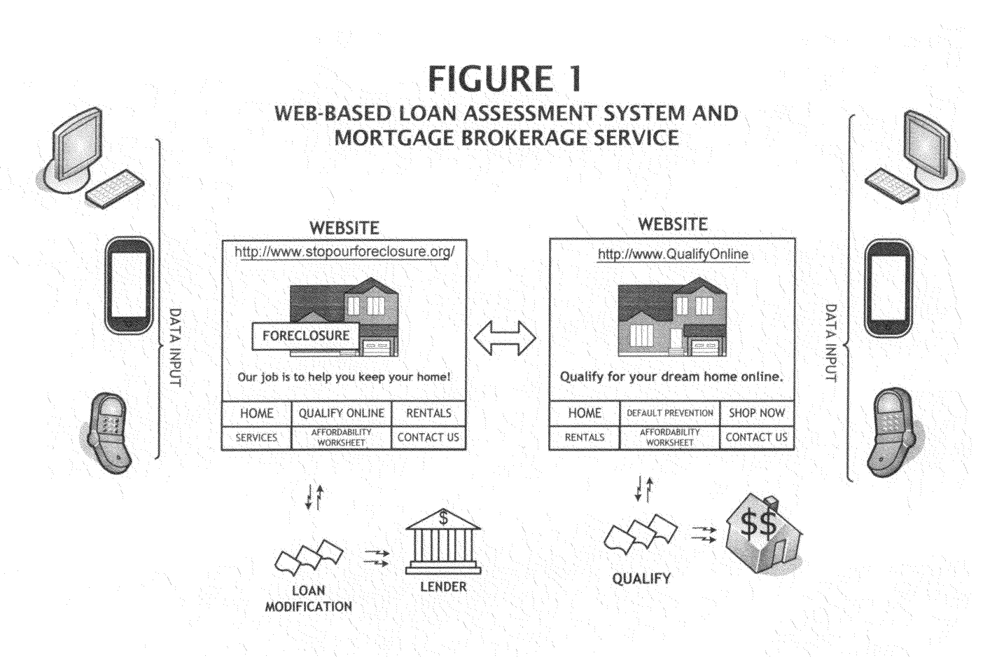

Referring now to the drawings, FIG. 1 depicts the preferred embodiment of the web-based home-loan assessment system and mortgage brokerage service of the present invention of the present invention.

The system of the present invention is used in preparing a detailed financial statement of borrower's income and expenses that the lender needs in making an informed determination on whether or not to modify the borrower's mortgage agreement. The home-loan modification assessment system and mortgage brokerage service of the present invention of the present invention comprises a website, a data input device, and a processor.

The website is easily found on the Internet using common search engines, such as Google® or Bing®. The borrower can readily query the website for issues that impact him and recent changes in federal or state laws and regulations. The website is user-friendly and is specifically designed to streamline the information-gathering process.

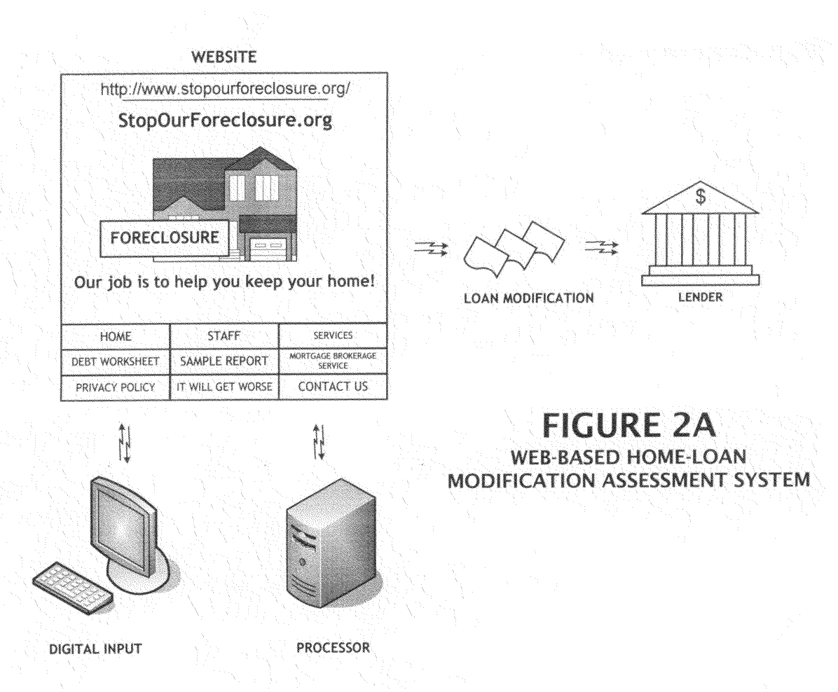

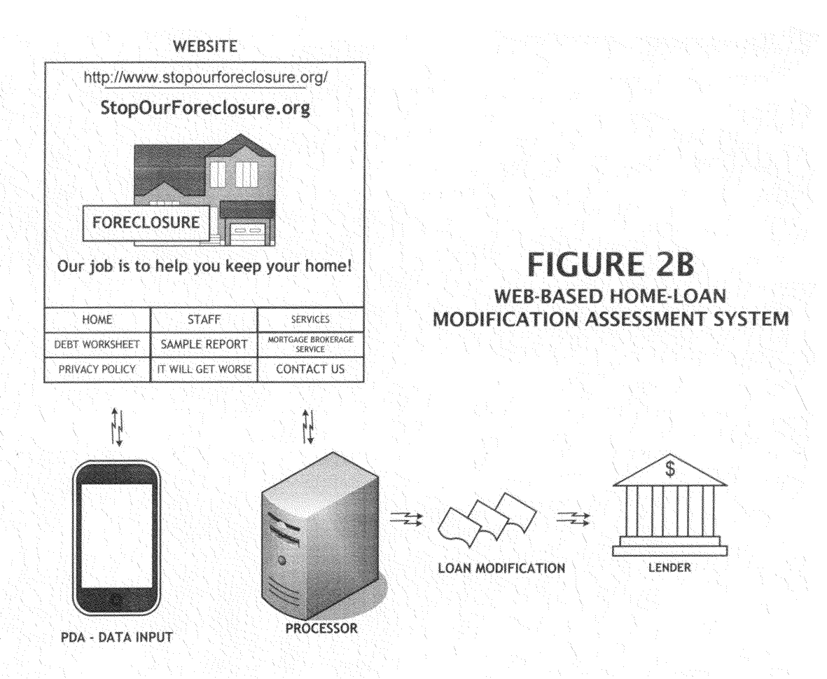

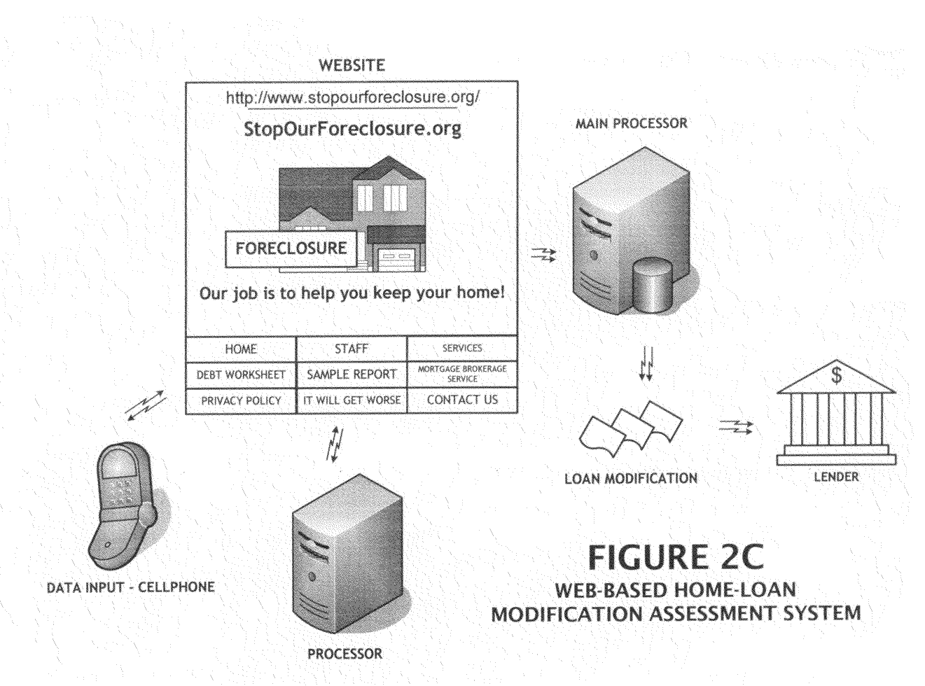

The data input device is preferably a keypad (see FIG. 2A), a pda (see FIG. 2B), or a phone (see FIG. 2C). Once the user locates the website, he scrolls through the pages and skims the various services that are provided.

The user submits answers online to the user-friendly questionnaire via the website about his current financial status, job status, savings, debits, credits, and his mortgage agreement with his lender. Once all the personal data has been submitted, a processor associated with the website organizes the personal data into a request form for a loan modification. The processor can be the processor associated with the website (see FIG. 2A), a processor specifically dedicated to preparing request forms from the website (see FIG. 2B), or a central processor with dedicated to preparing request forms from a number of websites (see FIG. 2C).

At least some of the personal data that is submitted is verified on-line in real-time. Credit checks are readily available from numerous sources. Other public records such as driving records, pending litigation may also be referenced in some instances.

The request form is then submitted to the borrower for review and approval in real time. If the calculations support proceeding to default, there is no need to submit a request for a home-loan modification. If the calculations support modifying the mortgage agreement, the information is submitted to the lender for review and consideration. The lender decision to modify the mortgage agreement is at least partially based upon a determination of the net present value.

In one preferred embodiment, the web-based home-loan modification system and mortgage brokerage service of the present invention, the borrower enters his personal and financial information via the Internet. Privacy is ensured by use of passwords and other means well-known in the art. The forms are designed so that the borrower answers are cross-checked for accuracy and key data is analyzed to ensure its integrity. This is necessary since the financially-distressed borrower generally needs a quick turn-around as to whether or not they qualify for relief under whatever federal programs are available, and if they do, a report needs to be quickly generated for the borrower signature or signatures and forwarded to the financial institution or lender for review and consideration under the program.

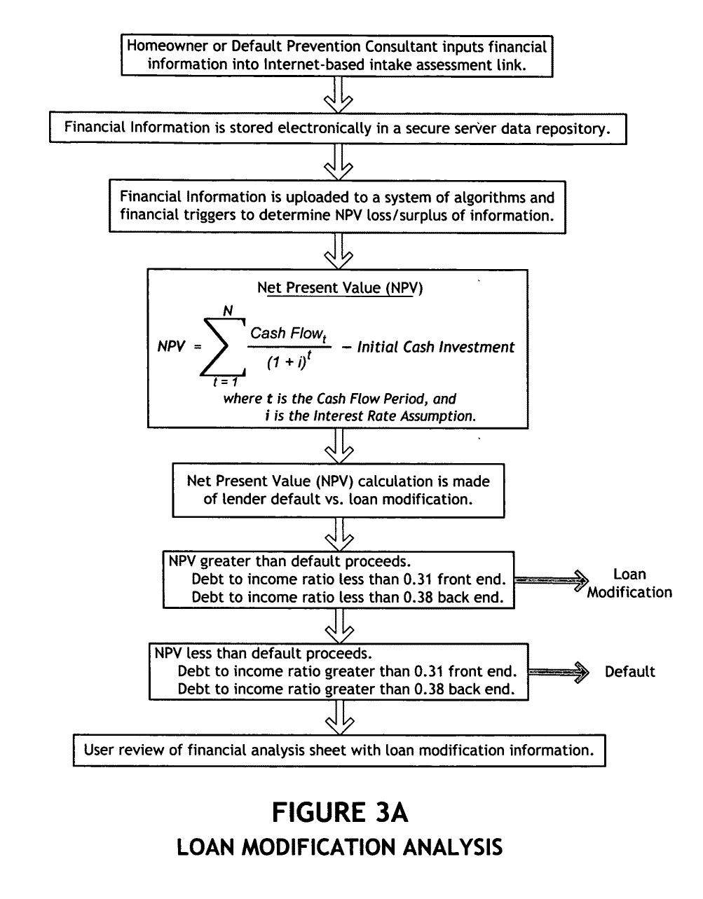

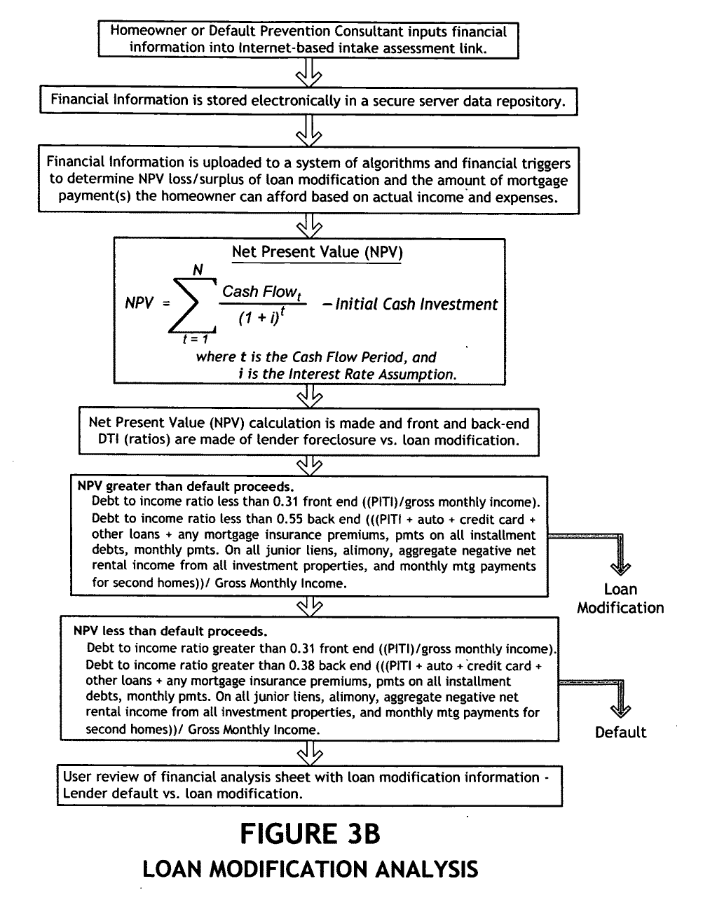

Referring now to FIGS. 3A and 3B, the net present value calculation is made to determine whether to tender a foreclosure or a loan modification to the lender. The preferred embodiment for calculating net present value (NPV) of the real property using the web-based home-loan modification system of the present invention is:

$$Net Present Value = {\sum }_{t = 1}^{N} \frac{Cash {Flow}_{t}}{{( 1 + i )}^{t}} - Initial Cash Investment$$

where “t” is the Cash Flow Period; and “i” is the Interest Rate Assumption. A second preferred embodiment for calculating net present value using the web-based home-loan modification system of the present invention is:

$$Net Present Value = {\sum }_{t = 0}^{N} \frac{Net Cash {Flow}_{t}}{{( 1 + i )}^{t}}$$

The present invention is an assessment method for determining home loan affordability for a financially-distressed borrower. The borrower is financially distressed because his income has been reduced or because his house payment has been increased.

Initially, the borrower submits personal data, so as to determine the amount that he is able to afford using either a front end, debt-to-income ratio, a back end, debt-to-income ratio, or both debt-to-income ratios.

Then, the net present value of the real property based is calculated. The net present value is a function of the current market value vs. the net proceeds that the lender would receive if the borrower were to default. The new house payment, if approved by the lender, is based upon the net present value calculation and lender specified debt-to-income calculations.

The website processor determines the amount that the borrower is able to afford using either a front end debt-to-income ratio, or back end debt-to-income ratio.

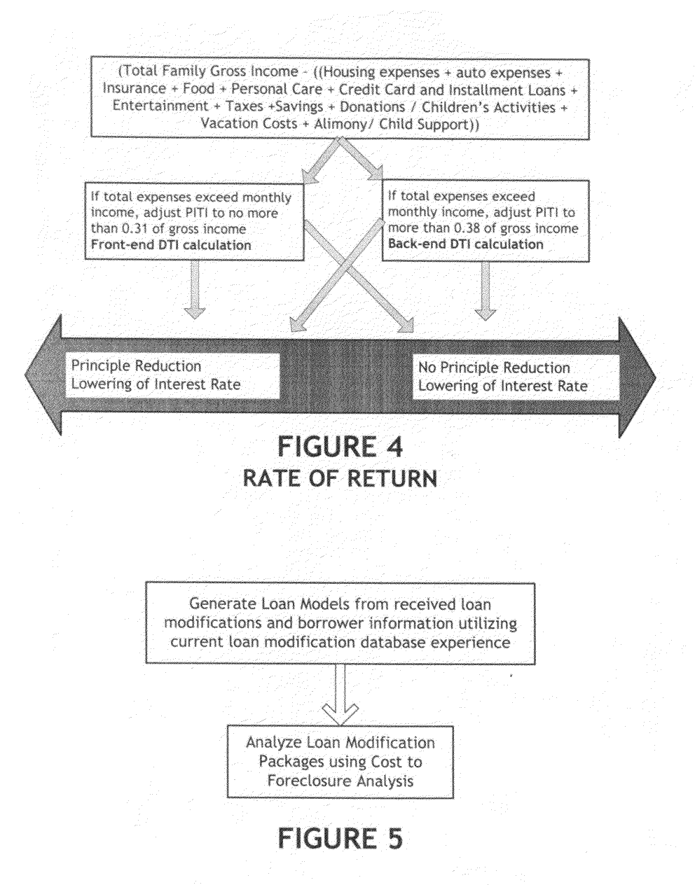

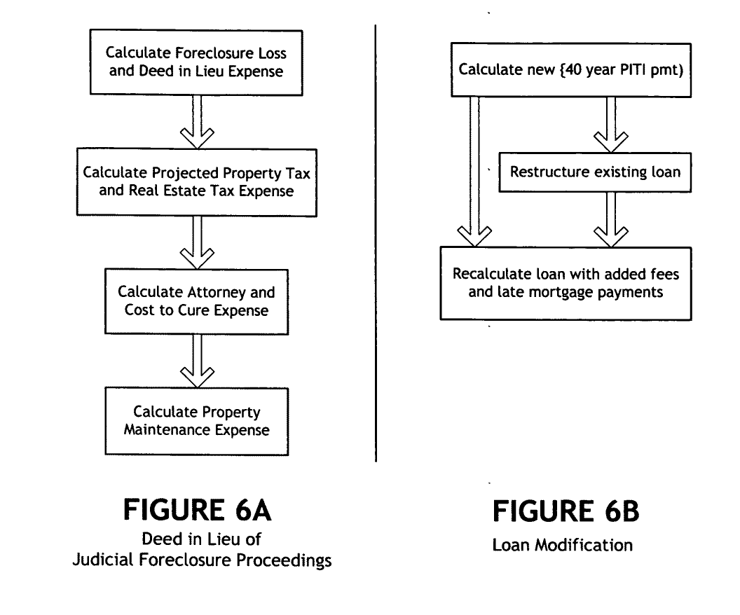

There are two primary types of debt-to-income ratios (see FIGS. 4 through 7):
1. The “front end, debt-to-income ratio” indicates the percentage of income that goes toward housing costs, which for people who are renting is the amount of their rent and for homeowners is PITI. (PITI includes mortgage principal and interest, mortgage insurance premium, hazard insurance premium, property taxes, and homeowners association dues).
2. The “back end, debt-to-income ratio” indicates the percentage of income that goes toward paying all recurring debt payments, including those covered by the “front end, debt-to-income ratio”, and other debts such as credit card payments, car loan payments, student loan payments, child support payments, alimony payments, and legal judgments.

If the net present value is greater than the foreclosure proceeds, a loan modification is appropriate if the “front end, debt-to-income ratio” is less than 0.31; and the “back end, debt-to-income ratio” is less than 0.38.

If the net present value is less than the foreclosure proceeds, a foreclosure is appropriate if the “front end, debt-to-income ratio” is greater than 0.31; and the “back end, debt-to-income ratio” is greater than 0.38.

However, there are occasions where the “front end, debt-to-income ratio” is less than 0.31, but the “back end, debt-to-income ratio” is greater than 0.38. Similarly, the “front end, debt-to-income ratio” is greater than 0.31; but the “back end, debt-to-income ratio” is less than 0.38. In such instances the lender will need to consider a variety of other factors in determining whether or not to accept the renegotiation request. Such factors include but are not limited to the market value of the property if the borrower defaults, the strength of the real estate market, the strength of the national and regional economies, the length of time that the property is likely to remain vacant, the amount that the payment will be reduced if the renegotiation is accepted, the stability of the job market in the community, the likelihood that this borrower will be back with another renegotiation request, the borrower's ties to the community.

The lender is then requested to modify the amount of the current home payment to enable the borrower to stay in the home, thereby deferring or stopping the default process. If appropriate, the real estate mortgage agreement between the lender and the borrower is modified.

If the net present value is less than the foreclosure proceeds, a negotiation may be appropriate between the borrower and the lender to modify the amount of the current house payment to enable the borrower to stay in the home. This may either defer or stop the foreclosure process.

The system is web-based. A computer interface transmits borrower inputs to, and receiving outputs from, a central server, for receiving inputs from, and providing outputs to borrower. The inputs and outputs relate to a proposed workout between the lender and borrower. The central server computer includes a central processing unit that calculates specific workout decision analysis for an approval of the proposed workout if certain predefined parameters are met. In the preferred embodiment of the present invention, once the applicant has submitted the necessary data, preferably via the Internet, and the system determines whether or not a loan modification is in order, the necessary forms are generated by the system of the present invention, and such forms are submitted to the lender for consideration and action. Once approved by the borrower, the forms are signed and submitted to the lender in real time.

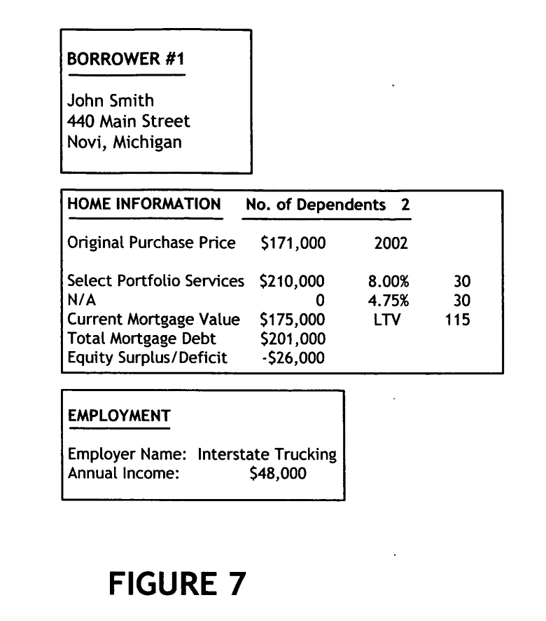

Referring now to FIG. 7, the following example demonstrates how a preferred embodiment of the web-based home-loan modification system of the present invention is applied. The borrower has a monthly income of $4000. Current monthly budget expenses are $3308, including taxes and insurance. The current monthly house payment is $1475, which is beyond the borrower's means at this time, resulting in a monthly cash flow of negative $783 (see below).

| Monthly | Current Monthly | Current Monthly | Monthly |
|---|---|---|---|
| Income | House Payment | Budget Expenses | Cash Flow |
| $4000 | $1475 (incl. tax & insur.) | $3308(incl. princ. + | −$783 |
| | | int.) | |

| Proposed Modified | Current Monthly | Monthly |
|---|---|---|
| House Payment | Budget Expenses | Cash Flow |
| $609 (incl. tax & insur.) | $3285 (incl. princ. + int.) | +$106 |

The proposed modification of reducing the house payment to $609 is within the budget means of the borrower and creates a situation whereby the borrower meets the monthly payment obligation and stays in the home.

Under the Home Affordable Modification Program Guidelines of the U.S. Treasury Dept. issued on Mar. 4, 2009, the front-end DTI ratio is 31% and the back-end DTI ratio is 38%.

Furthermore, although the embodiments above refer to processing information related to mortgages, systems and methods consistent with the present invention may process information related to loans or other financial data.

Systems and methods consistent with the present invention also include computer readable media that include program instruction or code for performing various computer-implemented operations based on the methods and processes of the invention. The media and program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

Another preferred embodiment of the web-based home-loan modification system and mortgage brokerage service of the present invention determines the maximum mortgage payment based on income.

The Home Affordable Modification Program under the U.S. Treasury Guidelines, the front-end DTI ratio is 31% and the back-end DTI ratio is 31% (again using the guidelines of Mar. 4, 2009).

| | | |
|---|---|---|
| The front-end DTI ratio under the U.S. Treasury | 31% | PASS |
| Guidelines | | |
| The back-end DTI ratio under the U.S. Treasury | 31% | PASS |
| Guidelines | | |
| Maximum Mortgage Payment | 31% | $936.58 |

The following is an example of a township of 20,000 homes that has experienced a change in tax revenues because of the 15% drop in home valuations from 2008 to 2009.

| | | | |
|---|---|---|---|
| 2008 | Capital Surplus | $400,000 | |
| 2008 | Total Revenue | $56,136,000 | |
| 2008 | Property Tax Revenue | $26,335,000 | 53% |
| 2009 | Estimated Property Tax Revenue | $22,384,750 | |
| | Variance* | −$3,950,250 | −7% |
| 2008 | Average Tax | $1,317 | |

| | | | |
|---|---|---|---|
| 2009 | Average Tax | −15% | $1,119 |
| | | | −$198 |

| | | | |
|---|---|---|---|
| 2008 | Total Expenses | $54,533,000 | 37% |
| | Public Safety | $19,969,000 | 6% |
| | Retiree Health Care | $3,100,000 | 5% |
| | Current Employee Healthcare | $2,500,000 | 47% |

The database contains the names of government programs, individuals, organizations, and institutions that assist individuals trying to stay in their homes, and minorities, people with disabilities, ethnics, minorities that provide assistance to financially distressed borrowers in danger of default. The contents of the database are continually updated.

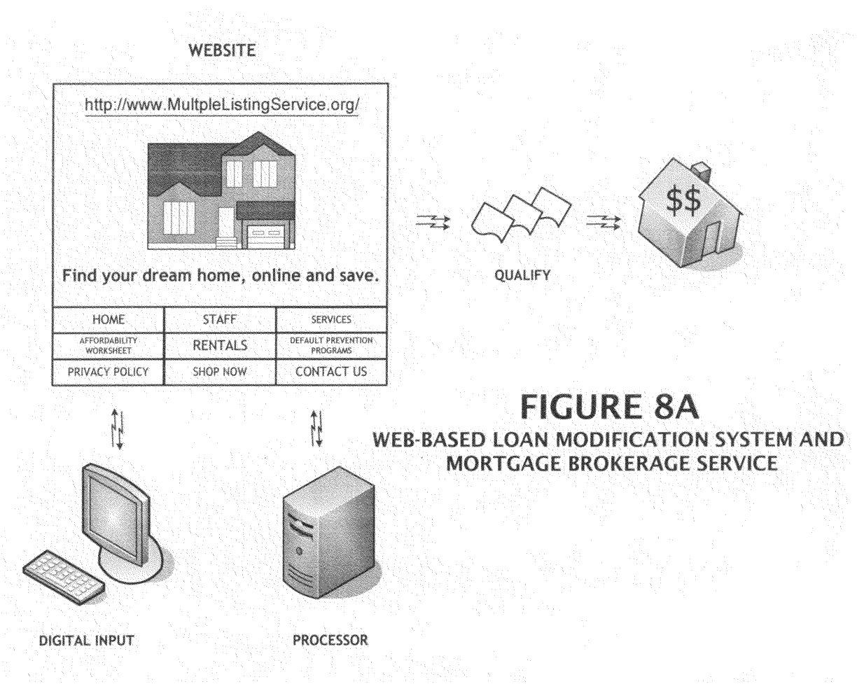

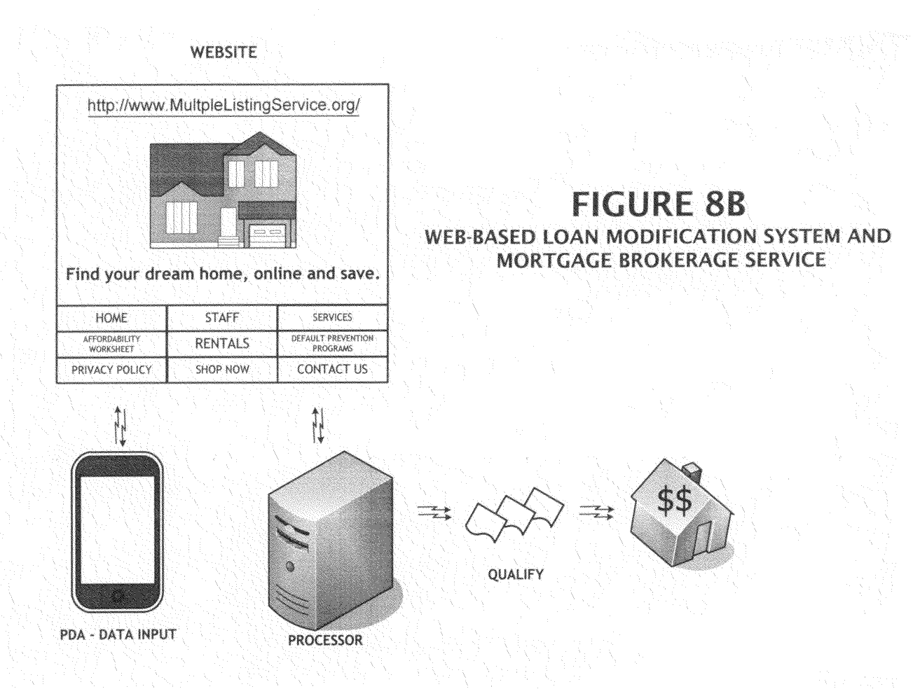

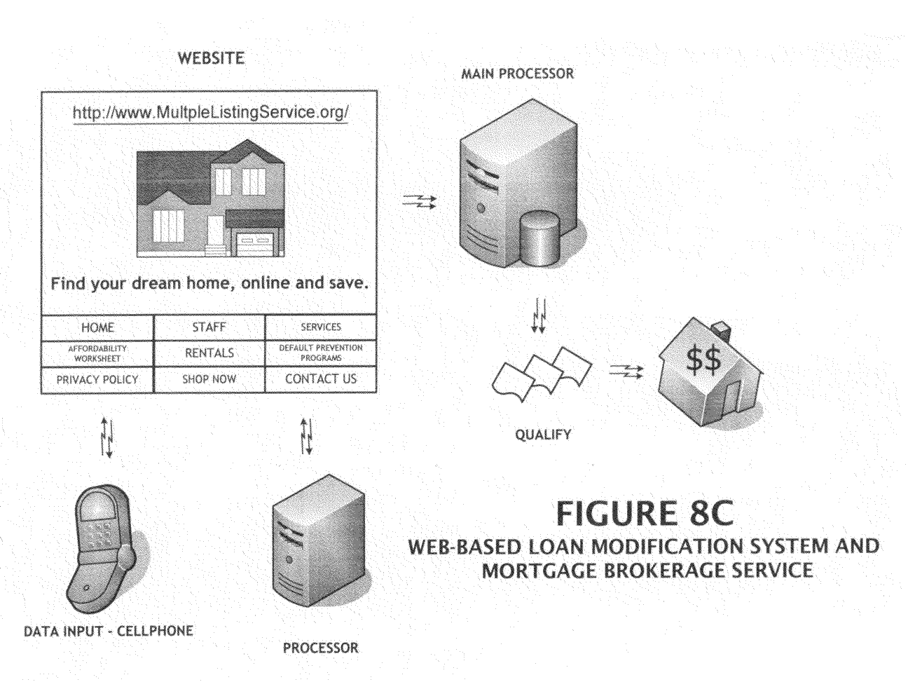

Referring now to FIGS. 8A, 8B, and 8C, the web-based home-loan modification system of the present invention also preferably includes a web-based mortgage brokerage service component. This component enables personal data to be submitted and organized for subsequent consideration for application to a mortgage broker or lender to qualify for a mortgage on a second real property, the mortgage application being submitted for review by the user in real time.

The web-based mortgage brokerage service component comprises a website, a data input device, and a processor. The web-based mortgage brokerage service component is registered by the mortgage brokerage service and easily found on the Internet using common search engines, such as Google® or Bing®, and is linked to the web-based home-loan modification system. The website is user-friendly and is specifically designed to streamline the information-gathering process.

The data input device is preferably a keypad (see FIG. 8A), a pda (see FIG. 8B), or a phone (see FIG. 8C). The user submits answers online to the user-friendly questionnaire via the website about his current financial status, job status, savings, debits, credits, and his mortgage agreement with his lender. Once all the personal data has been submitted, a processor associated with the website organizes the personal data into a request form for a loan modification. The processor can be the processor associated with the website (see FIG. 8A), a processor specifically dedicated to preparing request forms from the website (see FIG. 8B), or a central processor with dedicated to preparing request forms from a number of websites (see FIG. 8C).

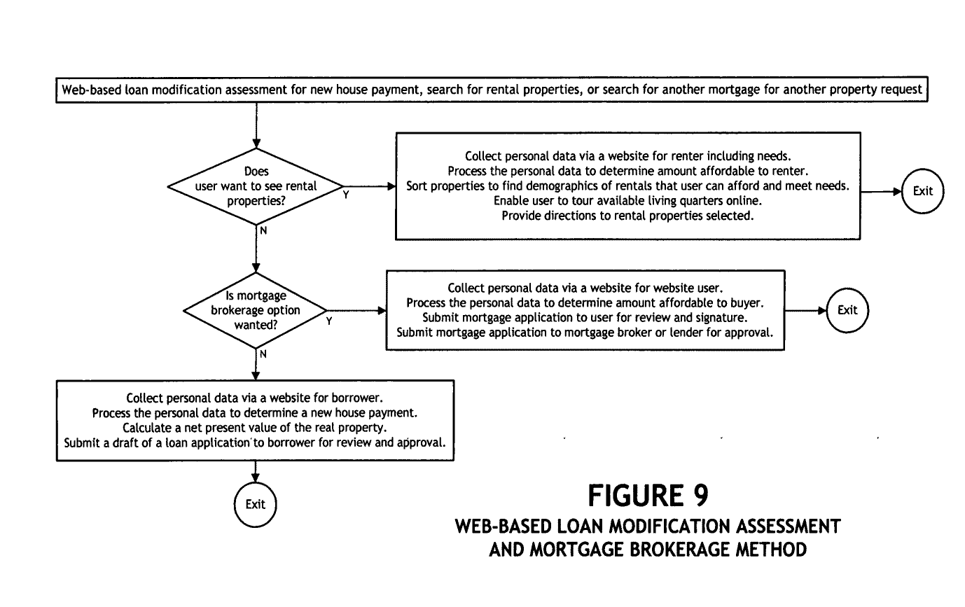

FIG. 9 discloses the preferred embodiment of the web-based home-loan modification assessment method for use with the home-loan assessment system of the FIGS. 1A, 1B, or 1C. The method calculates a new house payment that is affordable for a user based upon personal data submitted online via a user-friendly website. The method of the present invention also enables the user to determine the amount of a mortgage that he would qualify for on another property online via the user-friendly website. In addition, the method of the present invention enables the user to conduct a market analysis of relevant rental properties in selected communities online via the user-friendly website.

The web-based home-loan assessment modification system and mortgage brokerage service of the present invention also preferably includes a web-based rental assessment service enabling the user to conduct a market analysis through the website of rental properties in selected communities. The market analysis of residences for rent is available to the user in real time.

A reverse mortgage is a loan available to seniors, and is used to release the home equity in the property as one lump sum or multiple payments. The homeowners obligation to repay the loan is deferred until the homeowner dies, the home is sold. The homeowner makes no payments and all interest is added to the lien on the property. If the owner receives monthly payments, or a bulk payment of the available equity percentage for their age, then the debt on the property increases each month. If a property has increased in value after a reverse mortgage is taken out, it is possible to acquire another reverse mortgage over the increased equity in the home. But in certain countries, a reverse mortgage must be the only mortgage on the property. To qualify for a reverse mortgage, the borrower must be at least 62 years of age. There are no minimum income or credit requirements, but there are other requirements and homeowners should make sure that they qualify for the loan before they invest significant time or money into the process. For most reverse mortgages, the money can be used for any purpose; however, the borrower must pay off any existing mortgages with the proceeds from the reverse mortgage and, if needed, additional personal funds. Once the borrower makes application and has been given the proper information and consultation, the borrower is required to attend a HUD counseling session. During the loan and the remainder of its life, the borrower cannot be asked to leave the property, as the borrower is still the owner and deed holder. This is the case whether the borrower outlasts the performance of the loan or not. The property will be passed on to the heirs, and they can refinance out of the reverse mortgage within one year, from the passing to settle the mortgage.

An example of such a calculation for a reverse mortgage is set forth below calculating the new dti of a borrower by utilizing reverse mortgage proceeds:

| | | | | |
|---|---|---|---|---|
| If over age 62 | Current Age | 2010 | 1938 | 1938 |
| | 72 | | | |

| | | |
|---|---|---|
| Qualifies for Reverse Mortgage | YES | |
| Multiplier | | 49% |
| Current Market Value | | $185,000.00 |
| Available Reverse Mtg. Avalable | | $90,650.00 |
| Closing Costs | 10% | $9,065.00 |
| Net cash available for principal reduction | | $81,585.00 |
| New Principal Balance | | $221,415.00 |
| New Interest Rate | 5% | $1,188.60 |
| taxes and insurance | | $608.33 |
| Debt to Income Ratio | | 52% |

A primary service of the website is the home-loan modification service. However, the user may want to use the website to determine the local rental market, or the market for a new home in a certain neighborhood.

In another preferred embodiment, the web-based home-loan modification system and mortgage brokerage service of the present invention of the present invention enables the user to collect information about homes for sale and rental properties in specific communities, so that the user can make the best possible decision concerning a renegotiation with a lender. The lender has up-to-the minute data concerning home prices and so the user needs to be armed with similar data.

The website collects public information from local government recorder's offices concerning properties that have recently sold. The website collects information from the Multiple Listing Service® as to properties that are currently for sale in a community. In addition, the website is interfaced with one or more of the Internet map sites (such as Mapquest® or Yahoo®) to chart maps of the selected communities. Also, the website collects data from various rental agents concerning rental properties that are currently being marketed.

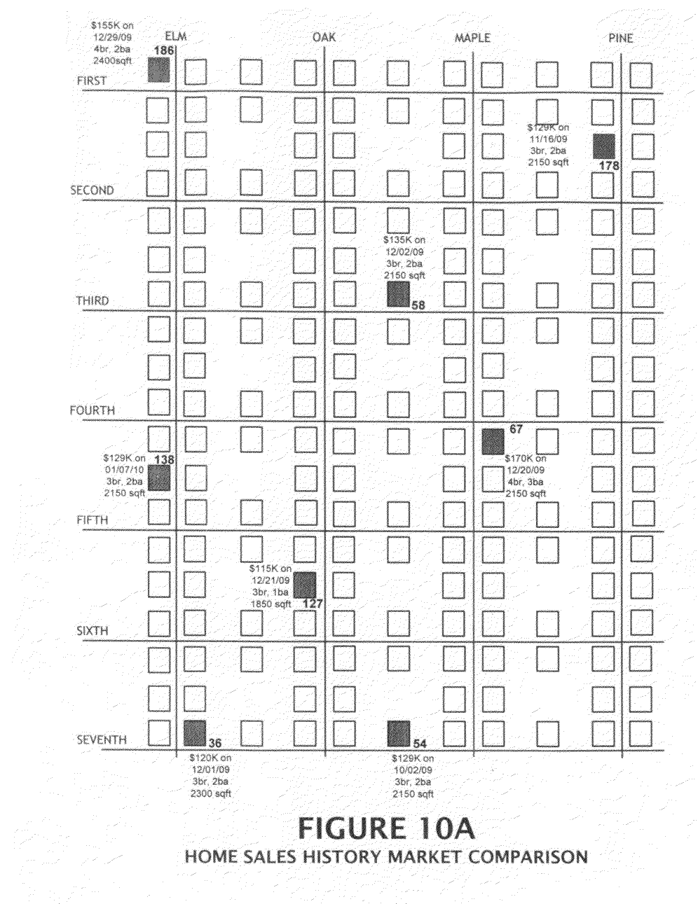

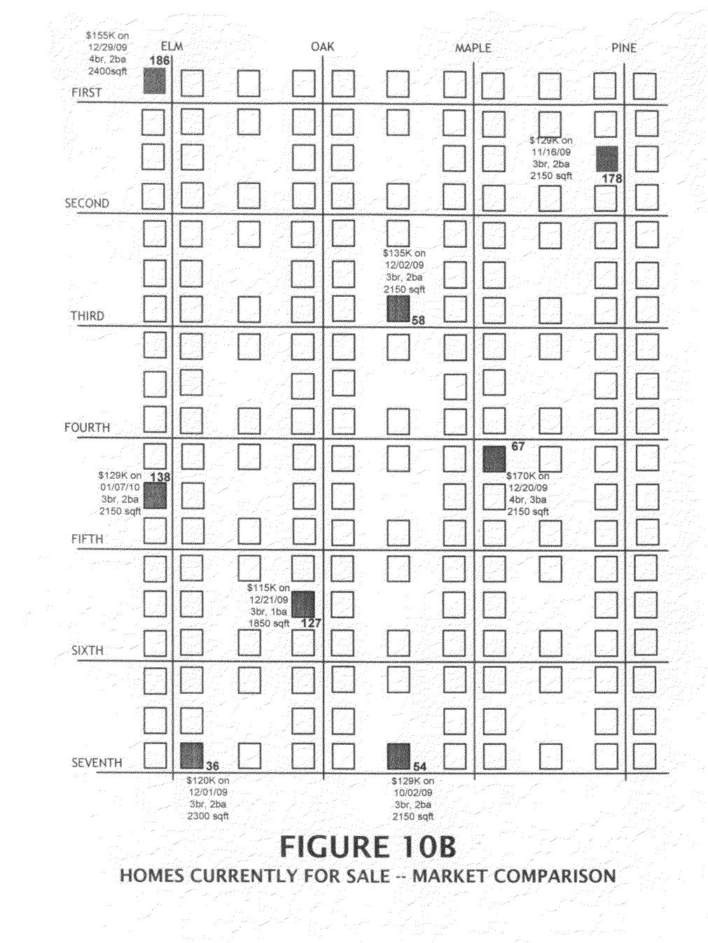

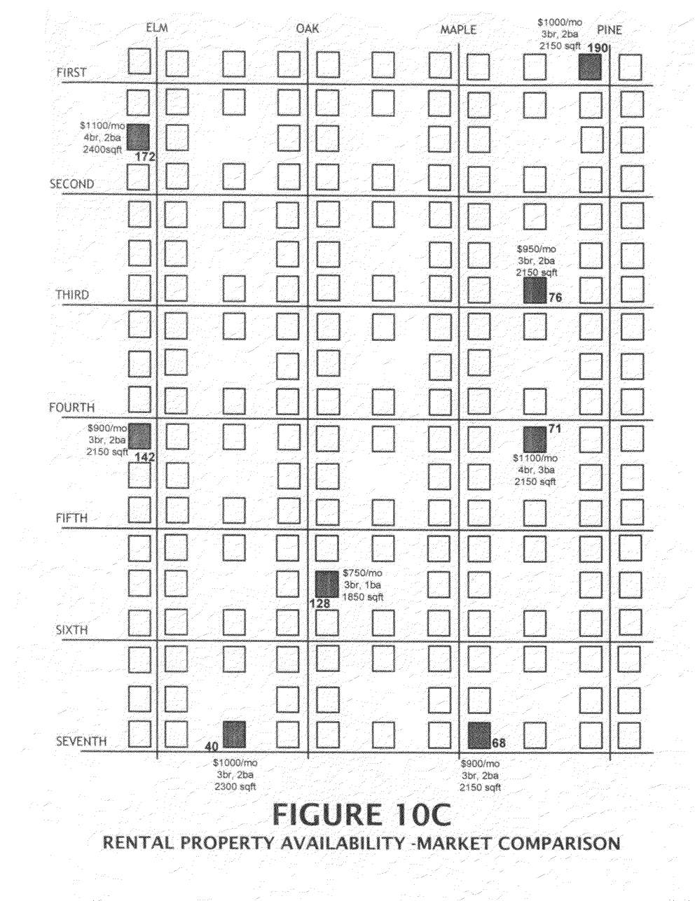

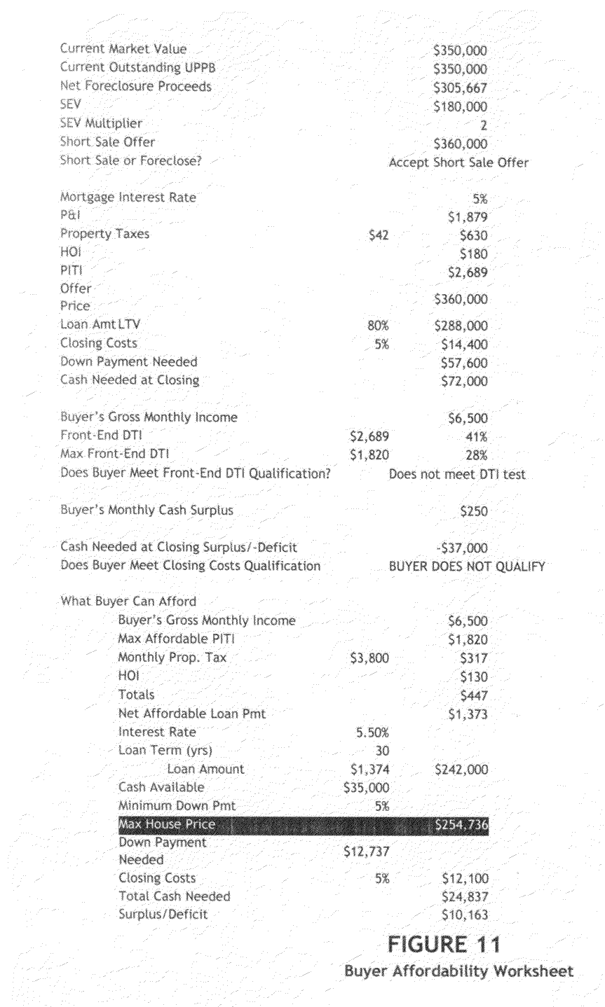

FIG. 10A is a market comparison of homes sales that were recently sold in a selected community. FIG. 10B discloses a market comparison of homes currently for sale in the selected community. FIG. 10C discloses a market comparison of homes currently available for rent in the selected community.

Signing writings serve the following general purposes:
evidence: A signature authenticates a writing by linking the signer with the signed document. When the signer makes a mark in a distinctive manner, the writing becomes attributable to the signer.
ceremony: The act of signing a document calls to the signer's attention the legal significance of the signer's act.
approval: A signature expresses the signer's approval or authorization of the writing, or the signer's intention that it has legal effect.
efficiency and logistics: A signature on a written document imparts a sense of clarity and finality to the transaction and may lessen the subsequent need to inquire beyond the face of a document.

A signature is a stylized script associated with a person. It is comparable to a seal. In commerce and in law, a signature on a document is an indication that the person adopts the intentions recorded in the document. The user's approval to the forms of the web-based home-loan modification system and mortgage brokerage service of the present invention can be by submitting signed documents.

However, the formal requirements for legal transactions, including the need for signatures, vary in different legal systems. The eSign Act of 2000 defines an electronic signature broadly to encompass a wide variety of different ways that two individuals have available when they want to meet and have an understanding. Non-limiting examples of electronic signatures identified in the eSign Act include a symbol, sound or process.

An electronic signature must attest to both the meeting of two minds and the willingness of two minds to meet. An electronic signature is any legally recognized electronic means that indicates that a person adopts the contents of an electronic message. An electronic signature means an electronic sound, symbol, or process attached to or logically associated with a record and executed or adopted by a person with the intent to sign the record.

The mathematics related to “digital signatures” are an improvement over handwritten signatures because it provides a certain and secure way to attest not only that two minds met and agreed on a subject but also when the meeting occurred. A digital signature means an electronic signature based upon cryptographic methods of originator authentication, computed by using a set of rules and a set of parameters such that the identity of the signer and the integrity of the data can be verified.

Throughout this Application, there are various Patents and Applications that are referenced by number and inventor. The disclosures of these patents in their entireties are hereby incorporated by reference into this specification in order to more fully describe the state-of-the-art.

It is evident that many alternatives, modifications, and variations of the combination web-based home-loan modification assessment system and mortgage brokerage services of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

I claim:

1. A web-based home-loan modification assessment system for assisting a user, said user having an agreement with a lender to purchase real property and make a house payment, said web-based home-loan modification assessment system comprising:
a. a web-based home-loan modification assessment system that has a website that enables personal data to be submitted and organized for subsequent consideration by a current lender regarding a loan modification of said agreement, organization of said personal data once said data has been input by said user being in real time;
b. a web-based mortgage brokerage service system that enables personal data to be submitted and organized for subsequent consideration for application to a mortgage broker or lender to qualify for a mortgage on a second real property, said mortgage application being submitted for review by said user in real time; and
c. a web-based rental assessment service enabling said user to conduct a market analysis through said website of rental properties in a selected neighborhood, said market analysis being available to said user in real time.

2. The web-based home-loan modification assessment system of claim 1, wherein said website enables said user to access the Multiple Listing Service®.

3. The web-based home-loan modification assessment system of claim 1, wherein said website enables said user to access the government records concerning recent home sales proximate to said real property.

4. The web-based home-loan modification assessment system of claim 1, wherein said website enables said user to access the data from a website rental service to determine the rental property market in said selected neighborhood.

5. The web-based home-loan modification assessment system of claim 1, further comprising said website enabling entry of personal data by said user, said personal data being useful to calculate a new house payment, said website enabling said user to compare said new house payment with the cost of relocating to a new site if said user opts to default.

6. A web-based home-loan modification assessment system for assisting a user, said user having an agreement with a lender to purchase real property and make a house payment, said web-based home-loan modification assessment system comprising:
a. a web-based home-loan modification assessment system that has a website that enables personal data to be organized for subsequent consideration by a current lender regarding a loan modification of said agreement, organization of said personal data once said data has been input by said user being in real time; and
b. a web-based mortgage brokerage service system that enables personal data to be submitted and organized for subsequent consideration for application a mortgage broker or lender to qualify for a mortgage on a real property, said mortgage application being submitted for review by said user being in real time.

7. The web-based home-loan modification assessment system of claim 6, wherein said website enables said user to access the Multiple Listing Service®.

8. The web-based home-loan modification assessment system of claim 6, wherein said website enables said user to access the government records concerning recent home sales proximate to said real property.

9. The web-based home-loan modification assessment system of claim 6, further comprising said website enabling entry of personal data by said user, said personal data being useful to calculate a new house payment, said website enabling said user to compare said new house payment with the cost of relocating to a new site if said user opts to default.

10. The web-based home-loan modification assessment system of claim 6, wherein said user submits an electronic signature on said loan modification agreement to said website or directly to said lender if said user approves of said loan modification agreement.

11. The web-based home-loan modification assessment system of claim 6, wherein said user submits a digital signature on said loan modification agreement to said website or directly to said lender if said user approves of said loan modification agreement.

12. A web-based home-loan modification assessment sytem for assisting a user, said user having an agreement with a lender to purchase real property and make a house payment, said web-based home-loan modification assessment system comprising:
a. a web-based home-loan modification assessment system that has a web-site that enables personal data to be submitted and organized for subsequent consideration by a current lender regarding a loan modification of said agreement, organization of said personal data once said data has been input by said user being in real time; and
b. a web-based rental assessment service enabling said user to conduct a market analysis through said website of rental properties in a selected community, said market analysis being available to said user in real time.

13. The web-based home-loan modification assessment system of claim 12, wherein said website enables said user to access the data from a website rental service to determine the rental property market in said selected neighborhood.

14. The web-based home-loan modification assessment system of claim 12, further comprising said website enabling entry of personal data by said user, said personal data being useful to calculate a new house payment, said website enabling said user to compare said new house payment with the cost of relocating to a new site if said user opts to default.

15. A web-based home-loan modification assessment system for assisting a user, said web-based home-loan modification assessment system comprising:
a. a web-based mortgage brokerage service system that enables personal data to be submitted and organized for subsequent consideration for application to a mortgagee to qualify for a mortgage on a second real property, said mortgage application being submitted for review by said user in real time; and
b. a web-based rental assessment service enabling said user to conduct a market analysis through said website of rental properties in a selected community, said market analysis being available to said user in real time.

16. The web-based home-loan modification assessment system of claim 15, wherein said website enables said user to access the Multiple Listing Service®.

17. The web-based home-loan modification assessment system of claim 15, wherein said website enables said user to access the government records concerning recent home sales proximate to said real property.

18. The web-based home-loan modification assessment system of claim 13, wherein said website enables said user to access the data from a website rental service to determine the rental property market in said selected neighborhood.
